(19) United States
(12) Patent Application Publication
(10) Pub. No.: US 2009/0035556 A1
(43) Pub. Date: Feb. 5, 2009

(54) ELECTRICAL CONDUCTIVE COMPOSITE MATERIAL AND PRODUCTION METHOD THEREOF

(76) Inventors: Kunio Shimada, Fukushima-shi (JP); Takayuki Takahashi, Sendai-shi (JP); Yoshihito Ozawa, Fukushima-shi (JP); Kazuhiko Fukuda, Fukushima-shi (JP); Yaoyang Zheng, Fukushima-shi (JP); Seong Hee Jeong, Higashimatsuyama-shi (JP)

Correspondence Address: Cheng Law Group, PLLC, 1100 17th Street, N.W., Suite 503, Washington, DC, 20036, US

(21) Appl. No.: 12/185,010

(22) Filed: Aug. 1, 2008

Related U.S. Application Data
(63) Continuation-in-part of application No. PCT/JP2007/055107, filed on Mar. 14, 2007.

(51) Int. Cl. B32B 5/16; B32B 15/04; B32B 9/04; H01F 1/04; G01L 9/16

(52) U.S. Cl. 428/328; 428/457; 428/447; 252/62.55; 73/754

(57) ABSTRACT

The invention provides an electrical conductive composite material having superior thermal and electrical conductive performances. The electrical conductive composite material can be obtained by curing a mixture of a liquid elastic polymeric material and a magnetic compound fluid, which is prepared by dispersing Ni powder and Cu powder in a magnetic fluid, in a magnetic field. In the electrical conductive composite material, network cluster is formed by aggregation of Cu particles and Ni particles.

This is a continuation-in-part patent application of International Application No. PCT/JP2007/055107 filed on Mar. 14, 2007.

### TECHNICAL FIELD

The invention relates to a composite material having great thermal and electrical conductive performances.

### BACKGROUND ART

An electrical conductive rubber is formed of an insulative rubber material with electrical conductive powder dispersed therein to have a pressure-sensitive electrical conductive performance, which exhibits insulative property in the absence of an external pressure applied thereon, but exhibits an electrical conductive performance in the presence of an external pressure applied thereon, and thus becomes widely utilized as switches and sensors of electrical and electronic devices. In addition, the electrical conductive rubber has also attracted attention in a rapidly developing robotics field as a material having a haptic function such as an artificial skin.

For instance, Japanese Patent Publication No. 1989-193342 proposes a pressure-sensitive electrical conductive rubber comprising a natural (or synthetic) rubber, an electrical conductive carbon, an insulative mica flake, a bloom agent such as fats and oils, and a surface-dry agent. The rubber is formed to enlarge the gap between the electric resistances in the absence and presence of the external pressure for improving the pressure-sensitive electrical conductive performance. Furthermore, Japanese Patent Publication No. 1993-81924 proposes an electrical conductive rubber composed of a rubber elastic binder and an alloy powder having an average composition formula of AgₓM₁₋ₓ (M means one or more metals selected from Ni, Co, Cu, and Fe. x ranges 0.001 to 0.4) and having an Ag concentration increasing toward its core. The electrical conductive rubber can prevent a time-dependent decrease of the electrical conductive performance, thereby improving its reliability.

However, the electrical conductive rubber is required to enhance thermal characteristic, such as thermal conductivity and the like, in addition to its durability and electrical conductivity when adapted for use in an application where a haptic performance is relied upon. From the viewpoint, it remains necessary to improve the conventional pressure-sensitive electrical conductive material.

### DISCLOSURE OF THE INVENTION

In view of the above problem, the present invention has been accomplished and has an object of providing a composite material having great thermal conductivity as well as pressure-sensitive electrical conductivity.

An electrical conductive composite material of the present invention is obtained by curing a mixture of a liquid elastic polymeric material and a magnetic compound fluid containing a magnetic fluid, Ni and Cu in a magnetic field.

In the present invention, the magnetic compound fluid (abbreviated as MCF) possesses an intermediate characteristic between the magnetic fluid (abbreviated as MF) and a magnetorheological fluid (abbreviated as MRF). Generally, the MF has small saturation magnetization, while the MRF is difficult to treat hydrodynamically due to sedimentation of its fluid particles and its powder-like behavior, causing problems in their engineering applications. In view of the above problems, the MCF is a developed functional fluid formed of a metallic material (metallic fine particle) and the MF.

The particularly preferable electrical conductive composite material of the present invention is obtained by curing the mixture of the liquid elastic polymeric material and the MCF with Ni powder and Cu powder dispersed therein in the magnetic field.

Preferably, the MF is a kerosene-based MF for the purpose of forming the electrical conductive composite material.

In addition, it is preferable that the liquid elastic polymeric material is a silicone rubber, especially a silicone-oil rubber for the purpose of forming the electrical conductive composite material.

Additionally, both contents of the Cu powder and the Ni powder are preferably in a range of 14-19 wt % of the electrical conductive composite material.

Furthermore, content of the MF is preferably in a range of 9-26 wt % of the electrical conductive composite material.

The present invention has another object of providing a method of producing the above electrical conductive composite material. Namely, a production method comprises a step of preparing the MCF including the MF, Ni, and Cu, a step of mixing the MCF with the liquid elastic polymeric material, and a step of curing the resultant mixture in the magnetic field.

In the curing step, the mixed material is preferably disposed between permanent magnets facing each other while being kept in a sheet-like form having a thickness of 1 mm or less.

It is particularly preferred that Ni particle and Cu particle respectively have an elongated shape with an average diameter of 3-7 μm and a dendritic shape with an average diameter of 8-10 μm.

Further features and advantages of the present invention will be clearly understood by the following best mode for carrying out the invention and examples.

### BRIEF DESCRIPTION OF THE DRAWINGS

FIG. 1 is an optical microscopic photograph of Ni particles forming an electrical conductive composite material of the present invention.

FIG. 2 is an optical microscopic photograph of Cu particles forming the electrical conductive composite material of the present invention.

FIG. 3 is an optical microscopic photograph of network cluster extracted from the electrical conductive composite material of the present invention.

FIG. 4 is a sectional microscopic photograph of the electrical conductive composite material of the present invention.

FIG. 5 (A) is an illustrated view of cluster formed by aggregation of Ni and Cu, and

FIG. 5 (B) is an illustrated view of cluster formed by aggregation of Fe and Cu.

FIG. 6 is a schematic view showing a method of manufacturing the electrical conductive composite material of the present invention.

FIG. 7 is a schematic view of an apparatus for evaluating thermal conductivity of the electrical conductive composite material.

FIG. 8 is a line graph showing the thermal conductivity of the electrical conductive composite materials cured in the presence and absence of a magnetic field.

FIG. 9 is a line graph showing the thermal conductivity of the electrical conductive composite material including Ni and Cu of the present invention and that of an electrical conductive composite material including Fe and Cu as a comparative example.

FIG. 10 is a line graph showing a relation between the thermal sensitivity of the electrical conductive composite material of the present invention and its thickness.

FIG. 11 is a schematic view of an apparatus for evaluating a pressure-sensitive electrical conductivity of the electrical conductive composite material.

FIG. 12 is a line graph showing a relation between electric resistance of the electrical conductive composite material of the present invention and its thickness.

FIG. 13 is a schematic view of another apparatus for evaluating the pressure-sensitive electrical conductivity of the electrical conductive composite material.

FIG. 14 is a line graph showing the pressure-sensitive electrical conductivity of the electrical conductive composite material of the present invention and a conventional electrical conductive rubber.

FIG. 15 is a line graph showing the pressure-sensitive electrical conductivity of the electrical conductive composite materials of the present invention at various mixing ratios.

FIG. 16 is a schematic view of a haptic sensor formed of the electrical conductive composite material of the present invention.

FIG. 17 includes a photograph (A), a schematic perspective view (B), and a schematic sectional view (C) of a pressure-sensitive sensor chip formed of the electrical conductive composite material of the present invention.

FIG. 18 is a schematic view of an apparatus for evaluating performance of the pressure-sensitive sensor chip shown in FIG. 17.

FIG. 19 shows a line graph showing a relation between external pressure and electric resistance of the pressure-sensitive sensor chip measured by the apparatus shown in FIG. 18.

FIG. 20 is a line graph showing a time-dependent change of an electric resistance of the pressure-sensitive sensor chip.

FIG. 21 shows a photograph of a switch formed of the pressure-sensitive sensor chip shown in FIG. 17.

FIG. 22 (A) is a photograph of a rubber sheet formed at its predetermined portions with the electrical conductive composite material of the present invention, and FIG. 22 (B) is a schematic view of (A) showing the portions formed of the electrical conductive composite material.

### BEST MODE FOR CARRYING OUT THE INVENTION

Hereafter, an electrical conductive composite material of the present invention and a production method thereof will be described in detail.

The electrical conductive composite material of the present invention is obtained by curing a mixture of a liquid elastic polymeric material and a magnetic compound fluid (MCF) containing a magnetic fluid (MF), Ni and Cu, in a magnetic field. Preferably, the electrical conductive composite material of the present invention is obtained by curing the mixture of the liquid elastic polymeric material and the MCF formed of the MF with Ni powder and Cu powder dispersed therein in the magnetic field.

In the present invention, both of Ni and Cu are utilized for the following reasons; Ni is more ferromagnetic than Fe or the like, combination use of Cu is suitable to enhance both thermal and electrical conductivities, and a characteristic structure of cluster is formed by aggregation of Ni and Cu in the electrical conductive composite material cured in the magnetic field, as further mentioned below.

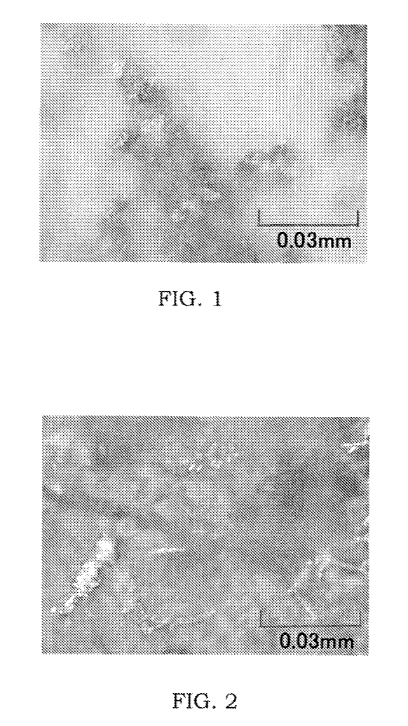

For the purpose of obtaining the MCF, the Ni powder is preferably added as Ni to the MF. It is particularly preferred that a Ni particle has of a non-spherical granular shape (shown in FIG. 1), a spherical shape with a plurality of projections, or an elongated shape with an average diameter of 3-7 μm. The Ni powder can be prepared by an atomization method.

In addition, the Cu powder is preferably mixed as Cu with the MF for the purpose of obtaining the MCF. Especially, a Cu particle preferably has a dendritic shape (e.g. having an average diameter of 8-10 μm), as shown in FIG. 2. The Cu powder can be prepared by an electrolysis method.

A kerosene-based MF is preferably utilized as the MF forming the MCF, as being compatible with silicone rubber suitable for the liquid elastic polymeric material. The MF may be the kerosene-based MF includes nm-sized (e.g. 10 nm-sized) spherical magnetite particles (Fe₃O₄) dispersed therein, or an alkylnaphthalene-based MF compatible with the silicone rubber. As explained above, the MF is composed of the magnetite particles and a base liquid, and the magnetite particles can aggregate the Ni particles and the Cu particles to form cluster while the base liquid is possibly trapped in polymers of the rubber provided as the liquid elastic polymeric material described below.

The MCF can be obtained by mixing the Ni powder, the Cu powder, and the MF at a predetermined mixing ratio. The mixing ratio is appropriately determined based on required thermal and electrical conductivity. Preferably, the weight percent ratios of the Cu powder, the Ni powder, and the MF are respectively in ranges of 14-19, 14-19, and 9-26 wt % of the weight of the electrical conductive composite material. Especially, high conductive performance can be achieved when the Cu powder and the Ni powder are added in equal amounts. As an example of manufacturing condition for achieving the best performance, the weight ratio of Ni to MF is preferably 3 to 4.

For the purpose of forming the electrical conductive composite material of the present invention, the elastic polymeric material is preferably the silicone rubber, especially a silicone-oil rubber. The elastic polymeric material may be another rubber material, but the silicone-oil rubber is especially preferable for its high elasticity and stretchability. The weight percentage of the elastic polymeric material is preferably in a range of 36-63 wt % of the electrical conductive composite material. As an example of manufacturing condition for achieving the best performance, the weight ratio of the MF to the elastic polymeric material is preferably 4 to 10. Since the mixture of the MCF and the liquid elastic polymeric material can be compulsorily performed by changes in mixing time and mixing force, viscosity of the liquid elastic polymeric material can be appropriately controlled based on mixing method and the like.

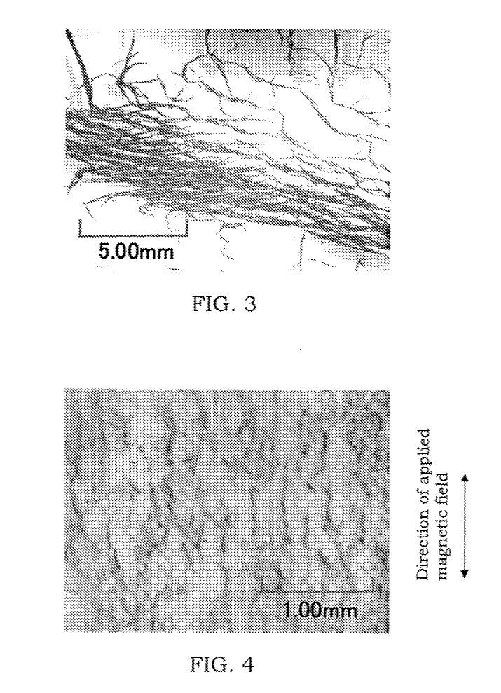

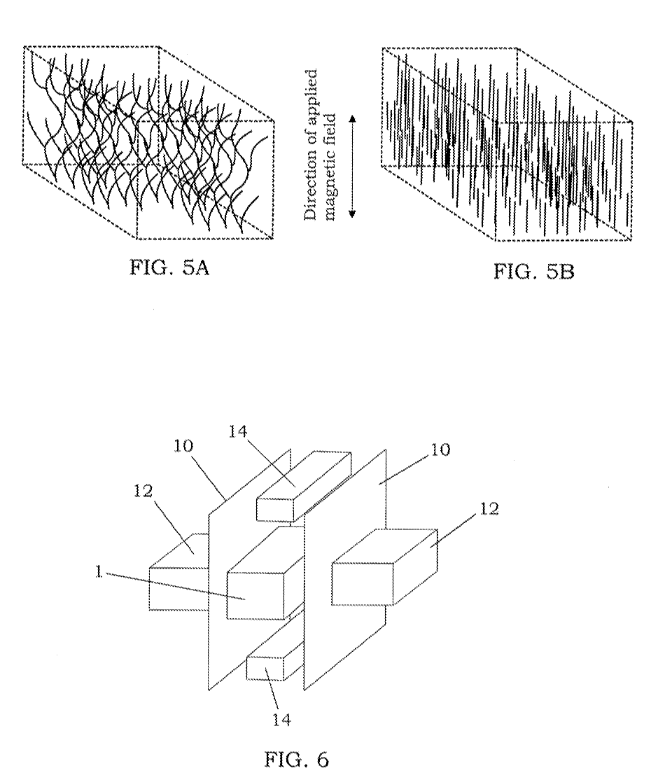

In the present invention, it is particularly essential that the mixture of the MCF and the elastic polymeric material is cured in the magnetic field. In the applied magnetic field, the Cu particles and the Ni particles can be aggregated to form a plurality of primary structures of cluster, i.e., linear structures of cluster respectively having dendritic forms. Then, the plurality of the linear structures of cluster comes in contact with each other to form three-dimensional huge network cluster (secondary cluster) in the electrical conductive composite material in the direction of the applied magnetic field. Since the linear structures of cluster are not to be bonded to each other, when expanded or contracted due to resiliency of the elastic polymeric material, the electrical conductive composite material is assumed to cause the linear structure of cluster to come into contact with different one or ones of linear structure of cluster. The structures of cluster will be now explained in details in the following examples, and can be visually understood with reference to FIGS. 3 and 4, and their schematic representation in FIG. 5(A).

Although the formation mechanism of the cluster is currently investigated, it can be mainly attributed to the following properties: the Ni particles magnetically attracting to other Ni particles or magnetite particles in the MF for a remanent magnetization of Ni, the dendritic structure of the Cu particle suited to form the network cluster, the projections on the non-spherical surface of the Ni particles highly influenced by the magnetic field, and so on. In the electrical conductive composite material, the network cluster is not randomly, but regularly oriented in the direction of the applied magnetic field, as shown in FIG. 5(A).

In the present invention, the non-conductive silicone-oil rubber utilized as the elastic polymeric material can include the above conductive network cluster, enabling to acquire not only the electrical conductive performance but also greater stretchability than conventional pure silicone-oil rubbers. The conductive silicone-oil rubber can be arranged to shorten an apparent total length of the network cluster formed of metal particles, that is, a “conductive wire” conducting electrons, so as to achieve small electric resistance. In the present invention, the electrical conductive composite material (rubber made of a MCF composite material) can be obtained by curing the mixture of the MCF and the silicone-oil rubber utilized as the elastic polymeric material in the magnetic field. The electrical conductive composite material can be referred to as an MCF electrical conductive rubber.

Next, an explanation is made as to a method of manufacturing the electrical conductive composite material. The production method comprises a step of preparing the MCF by dispersing Ni and Cu in the MF, a step of mixing the MCF with the liquid elastic polymeric material, and a step of curing the resultant mixture in the magnetic field.

In the manufacturing process, it is particularly important that Ni (e.g. the Ni powder) and Cu (e.g. the Cu powder) are sufficiently mixed with the MF to prepare uniform MCF, and then the elastic polymeric material is added to the resultant MCF.

For the purpose of heightening formation density of the cluster, the applied magnetic field in the curing step preferably has a strength of 5 kGauss or more, e.g. in a range of 5-5.8 kGauss, by use of a neodymium magnet or the like under the condition that the mixture of the MCF and the elastic polymeric material is kept in a sheet-like form having a thickness of 1 mm or less. In addition, a preparatory experiment clarifies that a lowered magnetic field reduces the formation density of the cluster, showing a tendency to decrease the electrical and thermal conductivities of the electrical conductive composite material. Therefore, a further strong magnetic field is preferably applied to a sheet-like form having a thickness of 1 mm or more. Under the above magnetic conditions, an electrical conductive composite material sheet can be provided with high electrical and thermal conductive performances.

In the curing step to form a thin MCF electrical conductive rubber having a thickness of 1 mm or less, the applied magnetic field can substantially heighten cluster density thereof in the vicinity of magnets. The high-density portions of the cluster can be partially cut down to be utilized. The high-density portions of the cluster can contribute to improving the thermal and electrical conductivities of the MCF electrical conductive rubber.

On exposure to air in ambient temperature, the above mixture begins to stiffen as well as general adhesive agents. The cluster is formed in the applied magnetic field before the mixture is cured. Thus, the structure of cluster is formed independent of the curing condition. The curing step is not limited to the above process but may be based on heat curing or chemical curing by curing agent and the like.

As a particularly preferred application of the electrical conductive composite material in the present invention, the electrical conductive composite material can be utilized as a detecting portion of a pressure-sensitive sensor, and as a contact of a pressure-sensitive switch. The electrical conductive composite material sheet can smoothly conduct electric current and heat in its thickness direction, and is preferably arranged to detect the electricity and heat in its thickness direction.

### EXAMPLES

Hereafter, detailed explanations is given as to an electrical conductive composite material in the present invention and a production method thereof with the reference to the following examples.

### Example 1

At first, 3 g of Ni powder (available from Yamaishi Metal Corporation Ltd. as “123”, an average particle diameter of 3-7 μm) and 3 g of Cu powder (available from Yamaishi Metal Corporation Ltd. as “MF-D2”, an average particle diameter of 8-10 μm) were put into a beaker, and mixed with 4 g of an MF (available from Ferrotec Corporation Ltd., kerosene-based, weight percentage of 50 wt %), and then stirred for several minutes by use of supersonic stirrer to sufficiently mix the MF with the Ni powder and the Cu powder. Next, 10 g of a silicone-oil rubber (available from Dow Corning Toray Silicone Corporation Ltd. as “SH9550”) was added to a mixture, and stirred for about 15 minutes by use of a propeller-type stirrer, and then degassed by a vacuum deaerator. (In this example, the degassing is performed for about 45 minutes.) Subsequently, a resultant mixture was poured between a pair of non-magnetic plates 10 with permanent magnets 12 being N-pole and S-pole disposed respectively on opposite sides of the magnet plates, as shown in FIG. 6, followed by being cured for several hours in a magnetic field. For the purpose of achieving the predetermined thickness of a resultant cured material, a pair of spacers 14 was disposed between the nonmagnetic plates 10. These procedures enable to form an electrical conductive composite material (MCF electrical conductive rubber) sheet 1 in example 1.

In the resultant electrical conductive composite material sheet, cluster is formed by aggregation of Ni particles and Cu particles. The structures of the cluster were investigated by the following procedures. While magnetic field was applied in a predetermined strength to the mixture (not including silicone-oil rubber) of the MF with the Ni powder and the Cu powder dispersed thereinto, the MF was washed out with a washing solvent a plurality of times to extract only network cluster (skeleton structure) formed by the aggregation of the Ni particles and the Cu particles. FIG. 3 shows a stereo microscopic photograph of the extracted cluster. FIG. 4 shows an optical microscopic photograph of the resultant electrical conductive composite material sheet. The observations show that the cluster has a three-dimensional network structure like a branched dendritic form. When Fe powder is adopted as a material forming cluster instead of the Ni powder, resultant cluster has linear structures apparently different from the network structure comprising Ni particles. FIGS. 5A and 5B are illustrated views showing structures of cluster in the electrical conductive composite material sheets, which are respectively formed of the Ni powder and the Cu powder in the present example, and formed of the Fe powder and the Cu powder.

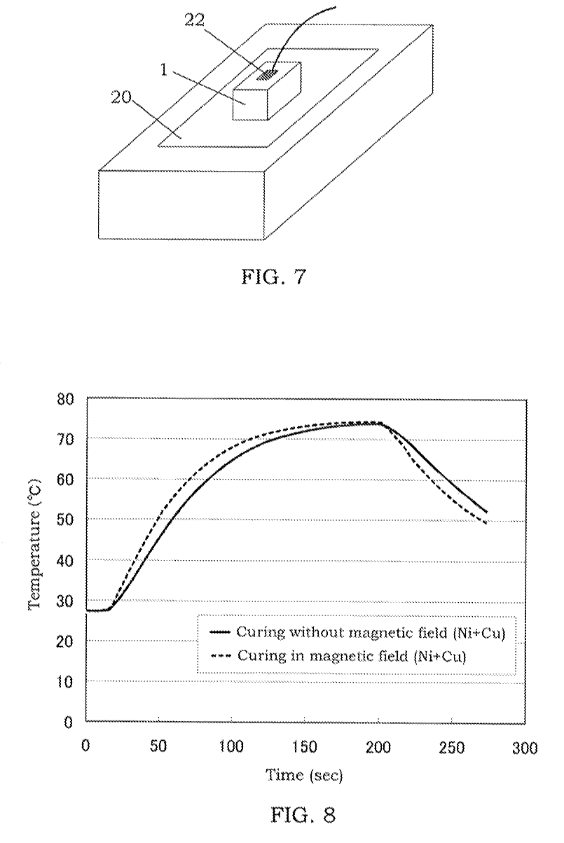

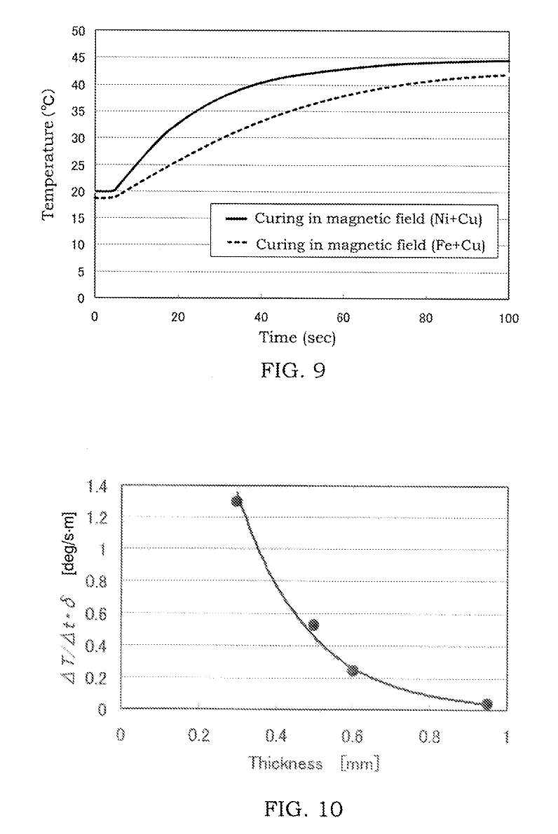

Next, thermal conductivity was evaluated for the resultant electrical conductive composite material sheet. Here, a thermal sensitivity refers to a time-dependent change in temperature of the composite material in contact with a highly-heated member having a certain temperature. The thermal sensitivity was measured by following procedures. As shown in FIG. 7, the electrical conductive composite material sheet 1 was arranged to contact its bottom with a heating part of a hot plate 20, and a thermocouple 22 was adhered to an upper surface of the electrical conductive composite material sheet. This arrangement enables to measure the time-dependent change in the temperature of the electrical conductive composite material sheet thermally conducted from the hot plate by use of the thermocouple. The measurement results are shown in FIGS. 8 and 9.

FIG. 8 shows the measurement result of the thermal sensitivity of the electrical conductive composite material sheet having a thickness of 0.646 mm in this example. This figure also shows a thermal sensitivity of an electrical conductive composite material sheet manufactured in the same procedure as this example in the absence of the magnetic field, as a comparative example. These results show that the composite material sheet cured in the magnetic field can rapidly increase the temperature thereof for a great thermal sensitivity. Although, the magnetic field was applied to the electrical conductive composite material sheet along its thickness direction in this example, it was confirmed that the composite material sheet can achieve comparable thermal sensitivity under the condition that the magnetic field is applied perpendicularly to its thickness direction.

FIG. 9 shows the measurement result of the thermal sensitivity of the electrical conductive composite material sheet having a thickness of 0.682 mm in this example. This figure also shows a thermal sensitivity of an electrical conductive composite material sheet formed of the Cu powder and the Fe powder in the same procedure as this example, as a comparative example. An apparent difference in the thermal sensitivity is shown between the two composite materials, probably exhibiting network cluster formation can contribute to improving the thermal conductivity of the electrical conductive composite material sheet in this example.

Next, in the manufacturing process of the electrical conductive composite material sheet 1, its thickness dependence on the thermal sensitivity was measured by a change in a distance between the nonmagnetic plates 10 as well as strength of the applied magnetic field in the curing step. This experiment was conducted on four kinds of the electrical conductive composite material sheets respectively having thicknesses of 0.298, 0.5, 0.601, 0.949 mm. Table 1 shows a relation among the thickness, the strength of the applied magnetic field, and ΔT/(Δt·δ). (ΔT, Δt, δ are respectively a change of temperature, a change of time, and the thickness) FIG. 10 shows a relation between the thickness of the electrical conductive composite material sheet and the ΔT/(Δt·δ).

TABLE 1

| Thickness | Strength of magnetic field | ΔT/(Δt · δ) |
|---|---|---|
| (mm) | (kGauss) | (deg/s · m) |
| 0.298 | 5.80 | 1.30 |
| 0.5 | 5.56 | 0.52 |
| 0.601 | 5.44 | 0.24 |
| 0.949 | 5.03 | 0.04 |

The observation of the resultant cluster shows the cluster density is increased with a decrease in the thickness. As shown in Table 1, the reduction in the thickness increases ΔT/(Δt·δ), and thus improves the thermal sensitivity. As to the electrical conductive composite material sheet, a temperature slope can be predicted based on its thickness by use of formula (1) below. In other words, the thickness of the electrical conductive composite material sheet can be appropriately determined for achieving a predetermined thermal sensitivity, easing a material design thereof.

ΔT/(Δt·δ)=6.81 exp^{-5.41δ} (1)

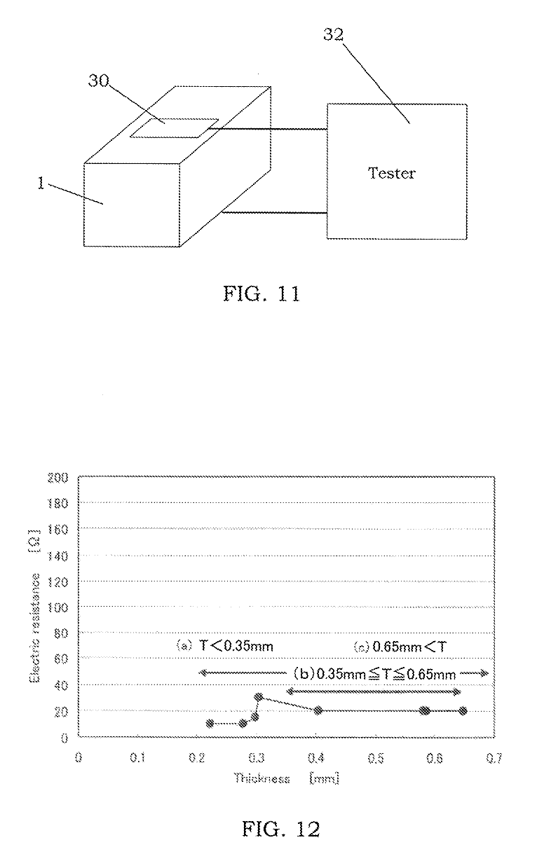

Next, a thickness dependence of pressure-sensitive electrical conductivity was evaluated as to the composite material sheet. Several kinds of the electrical conductive composite material sheets 1 were prepared in a variety of the thickness, and arranged to mount thereon a probe 30 having a dimension of 2 mm×2 mm, as shown in FIG. 11. With this arrangement, the variance in the electrical conductivity of the electrical conductive composite material sheet was measured by use of a tester 32 under an external pressure thereon with a finger. The measurement result of the electrical conductivity encloses the pressure-sensitive electrical conductive performance can be divided into three regions depending on the thickness T of the electrical conductive composite material sheet, as shown in FIG. 12. In the thickness T of the electrical conductive composite material sheet below 0.35 mm, the electric resistance is kept at tens of ohms. In the thickness T of 0.35 to 0.65 mm, the electrical conductive composite material sheet shows the electrical conductive performance by a small fraction of pressure applied thereon. In the thickness T in excess of 0.65 mm, the electrical conductive composite material sheet exhibits the electrical conductive performance under further strong pressure. These results enclose the good pressure-sensitive electrical conductive performance can be achieved when the electrical conductive composite material sheet of this example has a thickness of 0.65 mm or less. From an overall viewpoint with reference to Table 1 and FIG. 10, the cluster density can be increased with a decrease in the thickness, enabling to provide the electrical conductive composite material sheet with both of the thermal sensitivity and the pressure-sensitive electrical conductivity.

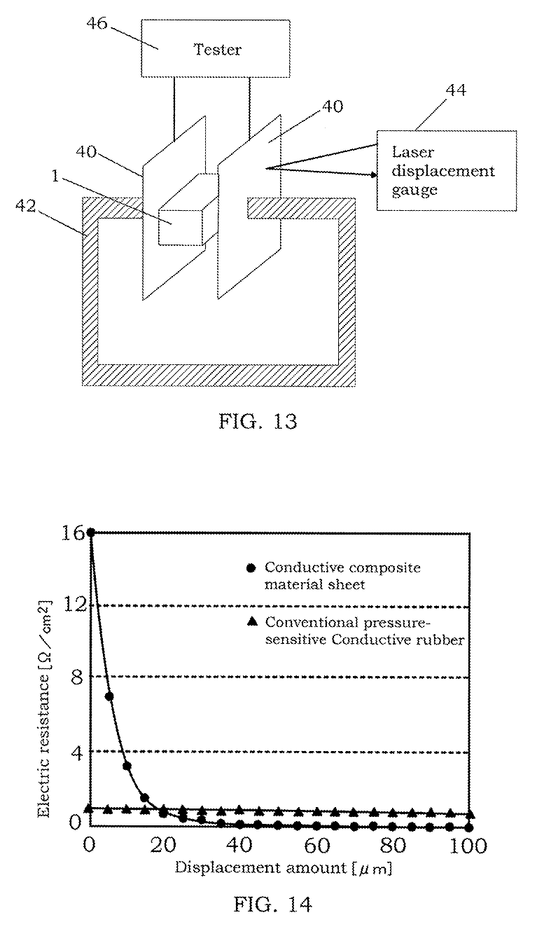

Next, the pressure-sensitive electrical conductivity was compared between the electrical conductive composite material sheet in this example and a conventional pressure-sensitive electrical conductive rubber (available from Yokohama Image System Corporation Ltd. as “CSA”). For the purpose of measuring the pressure-sensitive electrical conductivity, the electrical conductive composite material sheet 1 was disposed between a pair of metal plates 40, and compressed by a vice 42 on both external sides of the pair of metal plates, as shown in FIG. 13. Then, a displacement amount was measured by a laser displacement meter 44. A contact area is 15 mm×20 mm between the electrical conductive composite material sheet 1 and the metal plates 40. A variance in the electric resistance was measured by use of a tester 46 connected to the two metal plates 40 in an external pressure on the metal plates, as shown in FIG. 14. Since a contact area is 30 mm×30 mm between the conventional pressure-sensitive electrical conductive rubber and a metal plate, which is different from that of the present invention, unit of the electric resistances is converted into ohms per unit area, as shown in FIG. 14.

In the displacement amount of 20 μm or less by the applied external pressure, the electrical conductive composite material sheet in this example shows a higher electric resistance than the conventional pressure-sensitive electrical conductive rubber. In excess of 20 μm for the displacement amount, however, the electrical conductive composite material sheet shows a lower electric resistance and a greater electrical conductivity than the conventional pressure-sensitive electrical conductive rubber which hardly changes the electric resistance for its poor pressure sensitivity. These results enclose the electrical conductive composite material sheet shows higher pressure-sensitivity for greater change in the electric resistance than the conventional pressure-sensitive electrical conductive rubber.

### Examples 2 to 4

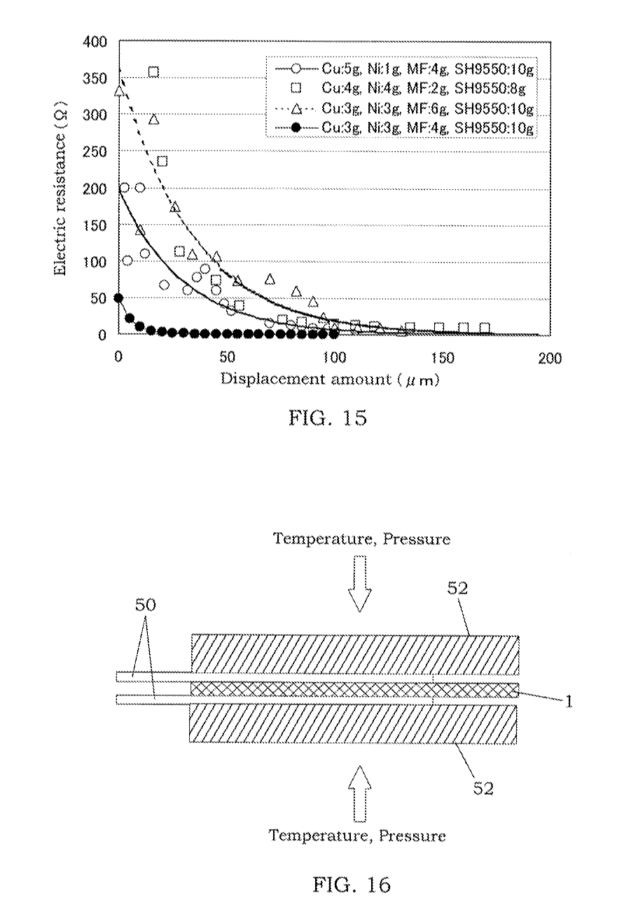

The electrical conductive composite material sheets of examples 2 to 4 were prepared by the abovementioned procedures in mixing ratios of the Ni powder and the Cu powder, the MF, and the silicone-oil rubber shown in Table 2, when its thickness was kept constant. FIG. 15 shows the resultant relation between the displacement amount and the electric resistance of the electrical conductive composite material sheet in each of the examples, measured by the apparatus shown in FIG. 13.

TABLE 2

| | Cu | Ni | Magnetic | Silicone-oil |
|---|---|---|---|---|
| | powder | powder | fluid (MF) | rubber |
| | (g) | (g) | (g) | (SH9550) (g) |
| Example 1 | 3 | 3 | 4 | 10 |
| Example 2 | 5 | 1 | 4 | 10 |
| Example 3 | 4 | 4 | 2 | 8 |
| Example 4 | 3 | 3 | 6 | 10 |

FIG. 15 shows the electrical conductive composite material sheet in example 1 can exhibit the greater electrical conductivity due to a small fraction of the displacement amount than those in example 2 where the Cu powder is added in a larger amount than the Ni powder, in example 3 where the Cu powder and the Ni powder are added respectively in a larger amount, and in example 4 where the MF is added in a larger amount. This result encloses the electrical conductive composite material sheets in example 1 are preferably utilized as materials of a switching device and a contact sensor which are configured to operate by the small fraction of the displacement amount.

As a preferred application example of the electrical conductive composite material sheet in the present invention, a brief explanation is made as to a haptic sensor formed of the electrical conductive composite material sheet in example 1. As shown in FIG. 16, the haptic sensor has a layer structure composed of a pair of conducting wires 50 arranged on both sides of the electrical conductive composite material sheet 1, a pair of non-electrical conductive rubbers 52 respectively disposed across the pair of the conducting wires on the both sides of the composite material sheet. When a small fraction of pressure is applied on both outer sides of the non-electrical conductive rubbers 52, the electrical conductive composite material sheet 1 inside the sensor exhibits electrical conductive performance, and conducts an electric current through the conducting wires 50, enabling the sensor to recognize the electric current as a haptic sense. The sensor can be provided at the electrical conductive composite material sheet with a thermocouple to act also as a great thermal-sensitive sensor.

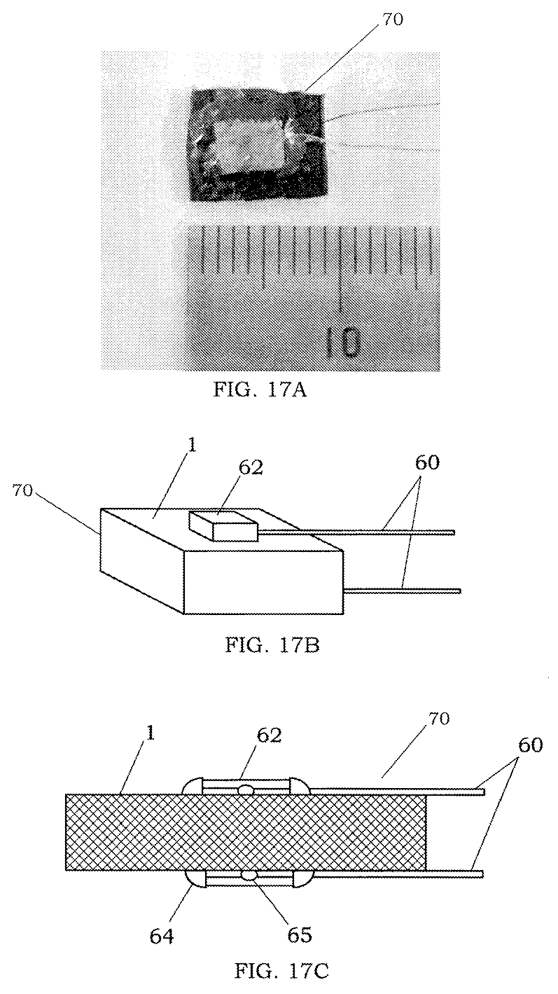

As a further preferred application example of the electrical conductive composite material in the present invention, a brief explanation is made as to a pressure-sensitive sensor chip 70 formed of the electrical conductive composite material sheet in example 1. As shown in FIGS. 17 (A) to (C), the pressure-sensitive sensor chip 70 comprises a pair of thin metallic plates 62 respectively adhered by an adhesive agent 64 to both sides of the electrical conductive composite material sheet 1 having a dimension of 6 mm×6 mm, a pair of conducting wires 60 electrically connected to the respective metallic plates through soldering portions 65. This configuration enables the electrical conductive composite material sheet 1 to exhibit electrical conductive performance by an external pressure applied on both sides of the trial pressure-sensitive sensor chip, conducting an electric current between the two conducting wires 60.

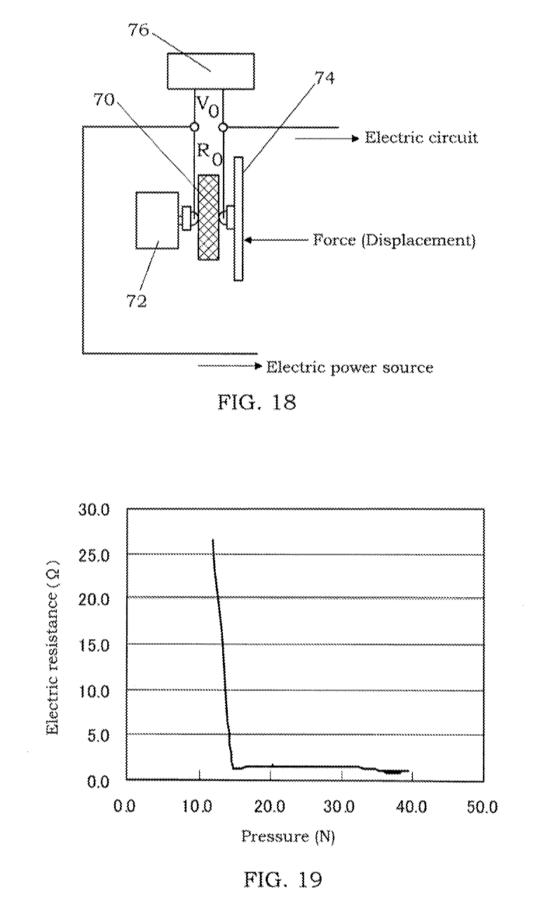

An apparatus shown in FIG. 18 was utilized for evaluating performance of the pressure-sensitive sensor chip 70. The pressure-sensitive sensor chip 70 was disposed between a fixed load cell 72 and a glass plate 74 for receiving an external pressure applied on both sides thereof. A code 76 in FIG. 18 shows a voltmeter. This configuration enables to measure the relation between the external pressure and the electric resistance of the sensor chip, and FIG. 19 shows one example of the measurement results. The figure obviously shows the electric resistance is steeply decreased with an increase in strength of the applied external pressure. In other words, the electric resistance is steeply dropped and kept at ca. 2Ω under the external pressure with the strength of about 15 N, when the displacement amount is about 45 μm (about 15 percents of its original thickness).

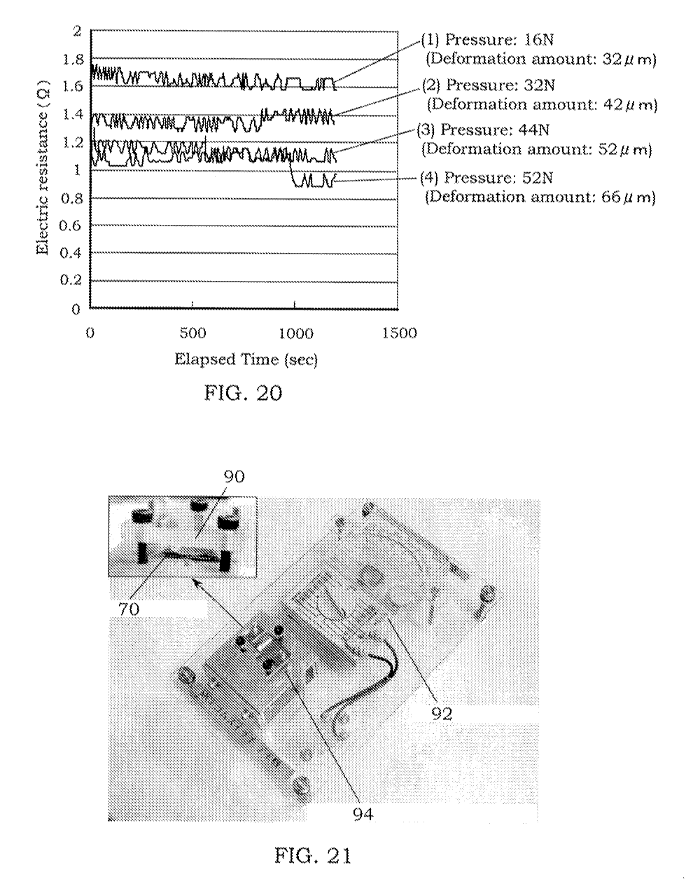

FIG. 20 shows a time dependence of the electric resistance of the pressure-sensitive sensor chip 70 compressed by the external pressure with the strength of 16N, 32N, 44N, and 52N. The figure shows the electric resistance scarcely fluctuates with time, regardless of the strength of the external pressure.

FIG. 21 shows a switch comprising the pressure-sensitive sensor chip as an example. A switch 90 is configured to conduct electric current through the pressure-sensitive sensor chip 70 when pressed. Codes 92 and 94 respectively show a circuit tester and a conductive wire connected to the electrical conductive composite material sheet in FIG. 21. The experimental result encloses that the sensor chip including the electrical conductive composite material can be utilized as a small-sized highly responsive pressure-sensitive switch.

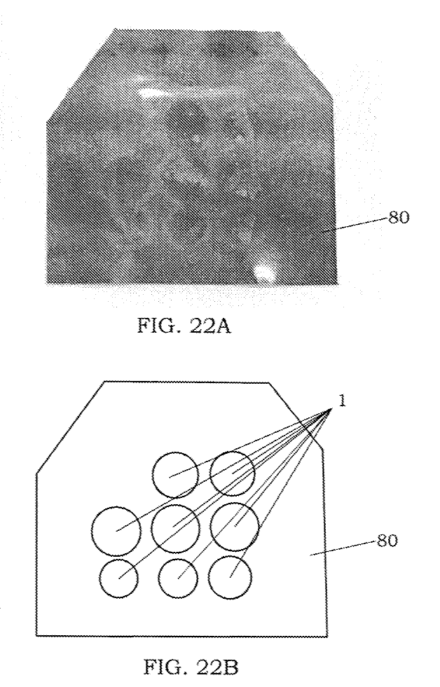

Furthermore, the electrical conductive composite material in the present invention can be obtained by curing the mixture of the liquid elastic polymeric material and the MCF containing the MF, Ni and Cu in the magnetic field, forming the characteristic network cluster by aggregation of the Cu particles and the Ni particles. Thus, the magnetic field can be applied only to predetermined portions of the mixture in the curing step, enabling to provide a rubber sheet 80 at the predetermined portions with the electrical conductive composite material 1, as shown in FIG. 22(A). Namely, the rubber sheet 80 is provided with switching function at its eight circular portions shown in FIG. 22 (B), by magnetic field having strength of 5-5.8 kGauss using a neodymium magnet applied only to the circular portions. This rubber sheet can be utilized to provide switching function at the portions as well as cover an entire surface of an apparatus or the like. With this arrangement, the present invention provides the rubber sheet having the performances of the electrical conductive composite material at its predetermined portions, possibly making the electrical conductive composite material widely applicable.

Although the explanation in the above examples is given as to the electrical conductive composite material made of the Cu powder and the Ni powder, the technical concept of the present invention is to form the structures of the network cluster and to provide the great thermal and electrical conductive composite material, and not intended to exclude the use of any powder of Ni or Cu containing particles (e.g. alloy powder), any powder of Ni or Cu coated particles, or the like. Metallic powder other than Ni and Cu may be added to the MF for preparing the MCF when needed.

### INDUSTRIAL APPLICABILITY

As described above, the present invention enables to provide a composite material having great thermal and electrical conductivity combined with a haptic function. The composite material is expected to become widely applicable in technical fields, for example a cellular phone, remote controllers, a mobile music player, a small-sized device requiring power-saving function as well as slimness and cheapness such as an electronic tag apparatus, a device requiring thermal conductivity and buffering capacity such as a contact detecting sensor in a stove, an apparatus requiring great elasticity such as a jointing portion of robot, a haptic sensor in a welfare robot supporting people, a pressure-sensitive switch, a haptic sensor such as an artificial skin, and the like.

1. An electrical conductive composite material obtained by curing a mixture of a liquid elastic polymeric material and a magnetic compound fluid containing a magnetic fluid, Ni and Cu in a magnetic field.

2. The electrical conductive composite material as set forth in claim 1, wherein said magnetic compound fluid is prepared by dispersing Ni powder and Cu powder in said magnetic fluid.

3. The electrical conductive composite material as set forth in claim 2, comprising network cluster formed by aggregation of Cu particles and Ni particles.

4. The electrical conductive composite material as set forth in claim 2, wherein said Ni powder comprises elongated Ni particles having an average diameter of 3 to 7 μm.

5. The electrical conductive composite material as set forth in claim 2, wherein said Cu powder comprises dendritic Cu particles having an average diameter of 8 to 10 μm.

6. The electrical conductive composite material as set forth in claim 2, wherein a content of said Cu powder in the electrical conductive composite material is in a range of 14 to 19 wt %, and a content of said Ni powder in the electrical conductive composite material is in a range of 14 to 19 wt %.

7. The electrical conductive composite material as set forth in claim 2, wherein a content of said magnetic fluid in the electrical conductive composite material is in a range of 9 to 26 wt %.

8. The electrical conductive composite material as set forth in claim 1, wherein said magnetic fluid is a kerosene-based magnetic fluid.

9. The electrical conductive composite material as set forth in claim 1, wherein said elastic polymeric material comprises a silicone rubber.

10. A pressure sensitive sensor with a detecting portion using the electrical conductive composite material as set forth in claim 1.

11. A pressure sensitive switch with a contact using the electrical conductive composite material as set forth in claim 1.

12. An electrical conductive composite material obtained by curing a mixture of a silicone rubber and a magnetic compound fluid, which is prepared by dispersing Ni powder and Cu powder in a magnetic fluid, in a magnetic field.

13. A method of producing an electrical conductive composite material comprising the steps of:
providing a magnetic compound fluid containing a magnetic fluid, Ni and Cu;
mixing said magnetic compound fluid with a liquid elastic polymeric material; and
curing a resultant mixture in a magnetic field.

14. The method as set forth in claim 13, wherein the curing step is performed under the condition that the resultant mixture kept in a sheet-like shape having a thickness of 1 mm or less is disposed between permanent magnets facing each other.

15. The method as set forth in claim 13, wherein said Ni is an elongate Ni particle having an average diameter of 3 to 7 μm, and said Cu is a dendritic Cu particle having an average diameter of 8 to 10 μm.

16. The electrical conductive composite material as set forth in claim 2, wherein said magnetic fluid is a kerosene-based magnetic fluid.

17. The electrical conductive composite material as set forth in claim 2, wherein said elastic polymeric material comprises a silicone rubber.

18. A pressure sensitive sensor with a detecting portion using the electrical conductive composite material as set forth in claim 2.

19. A pressure sensitive switch with a contact using the electrical conductive composite material as set forth in claim 2.

20. The method as set forth in claim 14, wherein said Ni is an elongate Ni particle having an average diameter of 3 to 7 μm, and said Cu is a dendritic Cu particle having an average diameter of 8 to 10 μm.
